(19) United States
(12) Patent Application Publication
(10) Pub. No.: US 2005/0033205 A1
(43) Pub. Date: Feb. 10, 2005

(54) Apparatus and method for passive and active hand and finger exercise

(76) Inventors: Andrei V. Komkin, Barnaul (RU); Alexander S. Pervov, Beaverton, OR (US)

Correspondence Address: SMITH-HILL AND BEDELL, 12670 N W BARNES ROAD, SUITE 104, PORTLAND, OR, 97229, US

(21) Appl. No.: 10/666,026

(22) Filed: Sep. 17, 2003

(30) Foreign Application Priority Data
Mar. 19, 2002 (RU) 2002107113

(51) Int. Cl. A61H 15/00

(52) U.S. Cl. 601/131; 601/137

(57) ABSTRACT

A therapy apparatus includes a container having an interior volume and having an opening providing access to the interior volume and massaging elements freely located in the interior volume of the container. Each massaging element has a generally spherical exterior and has multiple protrusions projecting from its generally spherical exterior. A patient who inserts his hand into the container through the opening and moves his fingers among the massaging elements is stimulated by massaging elements contacting his fingers both at the front and at the back of the hand.

### BACKGROUND OF THE INVENTION

This invention relates to an apparatus and method for passive and active hand and finger exercise, particularly for development of the functions of hands and fingers and of sensory faculties, and for stimulation of neuropsychic and speech development in children suffering from infantile cerebral paralysis.

An apparatus for passive and active hand and finger exercise, comprising a container and massaging elements in the container, is known. See, for example, USSR Author's Certificate No. 1537250 published Jan. 23, 1990. In this apparatus the massaging elements are particles made of electrifying materials, such as copper, zinc, ebonite, etc. When using this apparatus during physical exercise, the particles contact the hand and carry out physical and electrical stimulation of biologically active points.

Another apparatus for passive and active exercise of the hands and fingers is disclosed in G. V. Dedyukhina, L. D. Mogutchaya, T. A. Yanshina, “Logopedic massage and therapeutic physical training for 3-5 year old children, suffering from infantile cerebral paralysis,” M., “Gnom-Press,” 1999, p.17. This apparatus comprises a container and working elements freely placed in the interior space of the container. The working elements are peas or kidney beans. A patient exercises by immersing the hands in the mass of working elements or rolling the working elements between the palms of the hands. In this manner the muscles of the hand are massaged. Finger exercises, such as selecting and removing individual working elements and distributing the working elements according to size, help activate motor functions of the hands, manipulation skills, and small motor functions. Massage and exercise with this apparatus are not satisfactory because they do not influence the biologically active points to a significant degree. The working elements, being practically uniform in size, shape and color, do not affect the psychoemotional status of the child and do not favor teaching through play. Accordingly the apparatus has only a small influence on medical factors. Further, since the working elements are small, use of the apparatus with children of 6-7 years or younger is not advisable due to the danger of swallowing or penetration into a respiratory passage or the ear.

### SUMMARY OF THE INVENTION

In accordance with a first aspect of the invention there is provided a therapy apparatus comprising a container having an interior volume and having an opening providing access to said interior volume, and a plurality of massaging elements freely located in the interior volume of the container, wherein each massaging element has a generally spherical exterior and has a plurality of protrusions projecting from said generally spherical exterior, whereby a patient who inserts his hand into the container through the opening and moves his fingers among the plurality of massaging elements is stimulated by massaging elements contacting his fingers both at the front and at the back of the hand.

In accordance with a second aspect of the invention there is provided a method of administering therapy comprising providing a container having an interior volume and having an opening providing access to said interior volume, there being a plurality of massaging elements freely located in the interior volume of the container, wherein each massaging element has a generally spherical exterior and has a plurality of protrusions projecting from said generally spherical exterior, and instructing a patient to insert his hand into the container through the opening and move his fingers among the plurality of massaging elements, whereby the patient's fingers are stimulated by massaging elements contacting the fingers both at the front and at the back of the hand.

In accordance with a third aspect of the invention there is provided a massaging element having a generally spherical exterior and a plurality of substantially conical protrusions projecting from said generally spherical exterior, wherein the locations of the protrusions are selected by a method that comprises inscribing a spherical surface with a polyhedron composed of a plurality of regular polygons each having a center and multiple vertices, each vertex being common to exactly three polygons, and mapping the centers and the vertices of the polygons from the polyhedron onto the generally spherical exterior of the massaging element.

The present invention may be used to stimulate or develop many kinds of grasping or gripping actions, such as holding a massaging element in the palm of the hand, wrapping a finger around the massaging element, and holding the massaging element by the tips of the fingers.

The present invention may be used to provide an apparatus and method for passive and active hand and finger exercise, permitting point massage of the hand, particularly the hand of a child, and drawing the psychoemotional sphere of a patient into a medical or rehabilitational process, enriching or intensifying the therapeutic effect of the massaging elements and heightening the therapeutic effect and widening the field of use of the apparatus.

### BRIEF DESCRIPTION OF THE DRAWINGS

For a better understanding of the invention, and to show how the same may be carried into effect, reference will now be made, by way of example, to the accompanying drawings, in which

FIG. 1 is a perspective view of apparatus embodying the present invention,

FIG. 2 is an elevational view of a massaging element,

FIG. 3 is a sectional view of the massaging element,

FIG. 4 is another sectional view of the massaging element,

FIG. 5 is a sectional view of a second massaging element,

FIG. 6 is an elevational view of the second massaging element,

FIG. 7 illustrates a set of massaging elements of different size and color,

FIG. 8 is a sectional view of a third massaging element,

FIG. 9 illustrates a sphere inscribed with a polyhedron, and

FIG. 10 illustrates a massaging element embodying the present invention.

### DETAILED DESCRIPTION

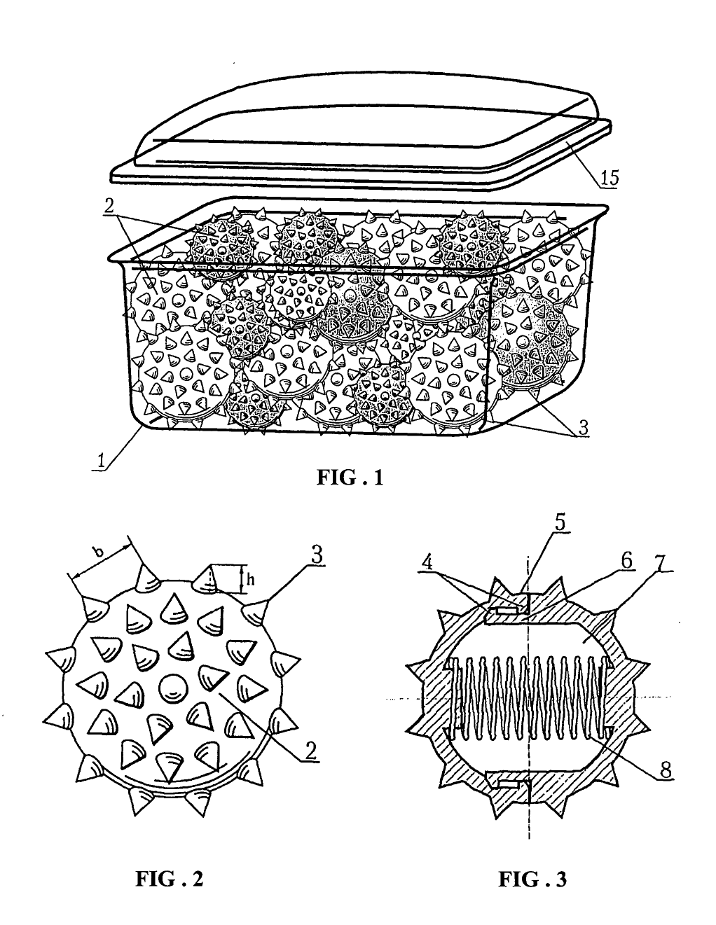

FIG. 1 illustrates a container 1 having generally vertical walls and a rectangular, horizontal base. The container is made of a tough, transparent, chemically resistant, waterproof material such as polypropylene and has a lid or cover 15 of the same or a similar material. In the event that the mouth of the container is circular, the cover may be threaded to allow the cover to seal the container.

Inside the container are multiple massaging elements 2. The massaging elements are freely located in the container, so that they can be moved around in the container by finger pressure. The bottom of the container may have recesses (not shown) for locating the massaging elements. Each massaging element has a generally spherical exterior surface. Conical massaging protrusions or lugs 3 project from the spherical exterior surface.

The massaging elements 2 are in three sets, although there may be more than three sets. Each set consists of seven or eight massaging elements. One set of seven massaging elements is shown in FIG. 7. The different massaging elements in a set are of different colors. The different colors may be the principal colors of the rainbow, and one of the massaging elements may be white. The different massaging elements in a set are of different respective sizes. The range of sizes is chosen on the basis of the hand structure and age of the patients. For patients aged from 3-7 years, the diameter of the smallest massaging element in a set may be 23-27 mm and the diameter of the largest massaging element in the set may be 35-40 mm. In another embodiment, the massaging elements of a given set are all the same size, and different sets are of different respective sizes. The massaging elements of the smallest set may be 23 mm in diameter, the elements of the next set may be 25 mm in diameter, the elements of the third set may be 27 mm in diameter, and so on.

The massaging elements may be solid and made of material having a Shore hardness number from 5-95, preferably from 40-75. Suitable materials include synthetic polymer materials, such as polystyrene, and wood. The massaging elements may be made of an electrifying material, i.e. a material on which an electrostatic charge can be induced, such as ebonite. The massaging protrusions must be sufficiently hard to provide the desired stimulation.

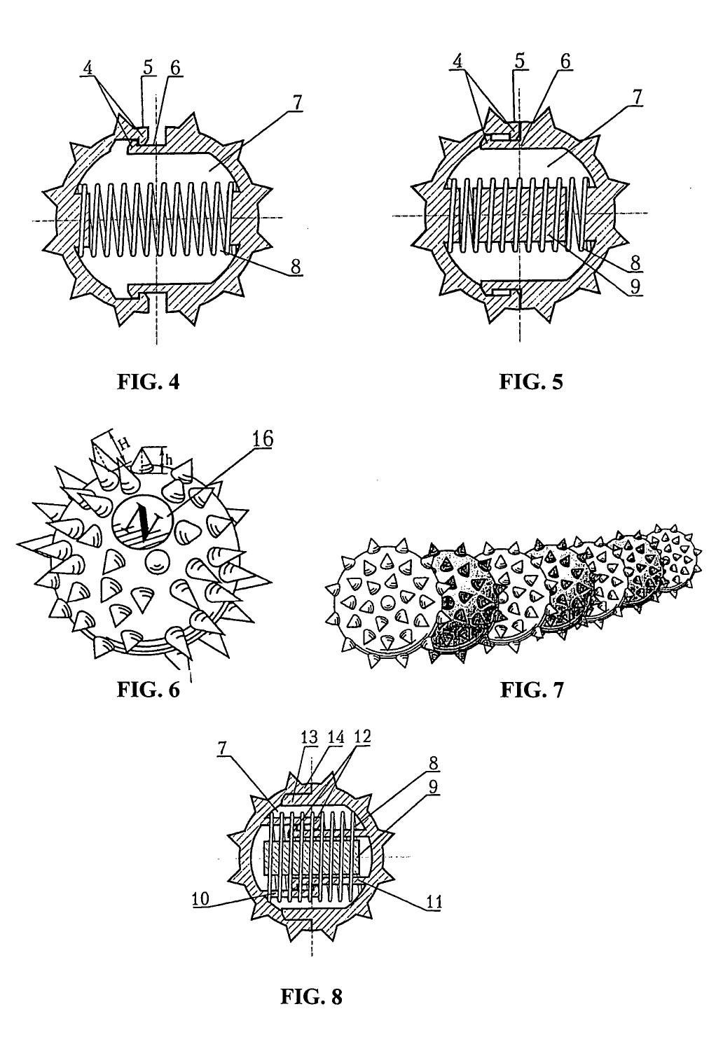

In another embodiment the massaging elements are hollow and are each assembled from two hollow hemispheres, as shown in FIG. 3. The two hemispheres are attached by mating hollow cylindrical fastening elements 5, 6 provided with interengaging latching members 4 that snap together and prevent separation of the hollow hemispheres. The two hemispheres are urged apart (within the limits of the latching members) by a compression spring 8 that is accommodated in the interior of the massaging element. The interaction of the mating fastening elements 6 and 5 allows relative rotation of the two hemispheres. FIG. 3 shows the two hemispheres when they have been squeezed together, for example by gripping between finger and thumb, and FIG. 4 shows the two hemispheres when no external force is applied and they are pushed apart by the force of the compression spring 8. In the case of FIGS. 3 and 4 the compression spring is a coil spring. In another embodiment, the compression spring may be made of a resilient material such as rubber.

FIG. 5 shows a cartridge 9 within the hollow massaging element. The cartridge 9 may contain another active element, such as a magnet, a sound producing element (e.g. a bell), or an aroma source having the fragrance of lemon or pine, or a heat-emitting or heat-absorbing element, for example.

FIG. 6 shows a region 16 of the surface of the massaging element that is generally flat, i.e. without massaging protrusions, and the massaging element has a second such region that is diametrically opposed to the region 16 shown in FIG. 6. The flat regions are large enough to allow the patient to grasp the massaging element between, for example, the tips of the thumb and middle finger without pressing against a massaging protrusion, which may be helpful in developing fine finger motor skills. As shown in FIG. 6, a flat region may be provided with a label 16 that indicates the nature of the contents of the cartridge 9 in that particular massaging element. For example, the label 16 shown in FIG. 6 displays the letter N to indicate that the massaging element contains a magnetic active element oriented with its north pole towards the label 16.

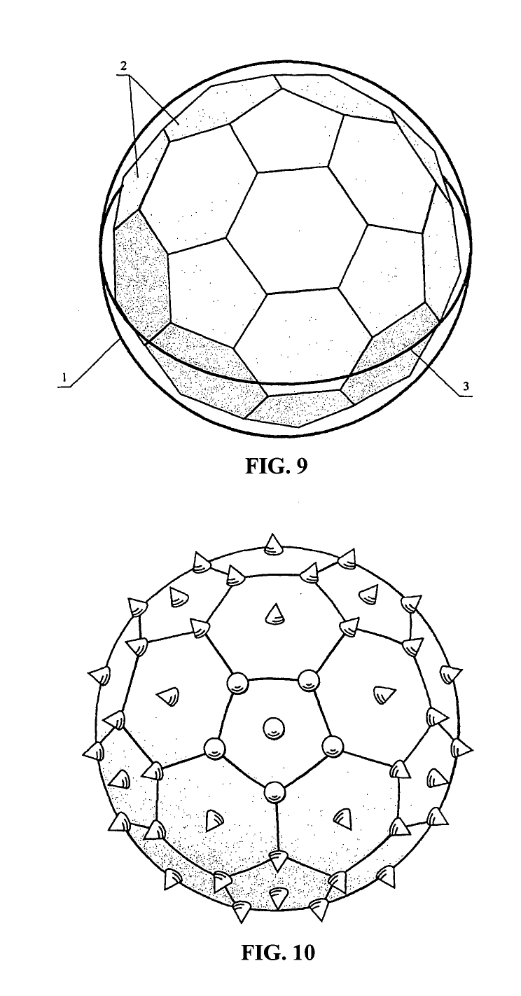

FIG. 8 illustrates another embodiment in which the two hemispheres are attached by mating hollow cylindrical fastening elements 10, 11 provided with interengaging latching members 12. One of the hemispheres 7 has a peripheral sleeve 14 that receives the rim 13 of the other hemisphere. The interaction of the mating fastening elements 10 and 11 allows relative rotation of the two hemispheres. The compression spring 8 surrounds the cylindrical fastening elements 10, 11 and the cartridge 9 is located within the inner fastening element 11.

In the case of FIGS. 2-5 and 8, the height h of the massaging protrusions is in the range 3-5 mm, and is preferably 4 mm. The tips of adjacent massaging elements are spaced apart at distance b in the range 3-8 mm, the preferred spacing, based on the distance between nerve ends (biologically active points) on the palm of the hand, being 6 mm.

In the case of FIG. 6, most of the massaging protrusions are of height h in the range 3-5 mm, and some of the protrusions are of height H, which is 1.5 to 2.6 times the height h of the majority of the protrusions. The taller protrusions are grouped together, as can be seen in FIG. 6. Including taller protrusions among the shorter protrusions provides a variation in massaging force as the massaging element rolls over the surface of the patient's hand, thus enhancing the effectiveness of the massage. The dimensions of the massaging protrusions are chosen based on safety and in order to maximize the influence on biologically active points.

The apparatus described with reference to FIG. 1 is particularly useful for rehabilitation after hand injuries, but it may also be used for other purposes, such as speech therapy. It has been found that particular sets of massaging elements are helpful in treating particular conditions. For example, for treatment of hand injuries it has been found that massaging elements containing magnetic active elements are useful. Specifically, for rehabilitation after a hand injury it is preferred to use six sets of massaging elements each comprising four elements, namely three blue elements 30 mm in diameter with no active element and one red element 40 mm in diameter with a magnetic element. For treatment of speech defects it is preferred to use two sets of massaging elements, each set comprising two yellow elements 25 mm in diameter with no active element, one orange element 25 mm in diameter with no active element, two pink elements 25 mm in diameter with a sound-emitting element, e.g. a bell, and one green element 25 mm in diameter with no active element.

The apparatus described with reference to FIG. 1 may be used for individual and group studies. For example, a child immersing the fingers of one or both hands into the container 1 may execute different exercises, such as squeezing the fingers together and forcing the fingers apart, bending and straightening the fingers, sorting the massaging elements, and rolling the massaging elements along the palm or the back of the hand. In addition to the exercise of the fingers and general massage effect of these activities, the massaging protrusions apply a local influence to biologically active points. Since the distance between the points of adjacent massaging protrusions corresponds to the distance between nerve receptors (biologically active points) in the palm of the hand, the massaging protrusions stimulate the nerve receptors. Providing massaging protrusions of different heights intensifies the therapeutic effectiveness of the massaging elements, because the level of stimulation by the massaging protrusions is not uniform and the biologically active points are influenced.

A therapist may use the apparatus to conduct therapy by play. For example, in a group where several patients each have a container with several sets of massaging elements, the therapist might ask the patients to locate and remove three red massaging elements, or one small massaging element and two large massaging elements. In this way, the patient learns counting, colors and manipulation. It is particularly important in the case of group therapy that the container be transparent, so that the therapist can observe the activities of the patients, and made of chemically resistant material, so that the container and its contents can be washed with disinfectant after use.

Typically, a doctor treating a child having a neuropsychic disorder will prescribe a course of treatment, which would be supervised by a therapist, in which the child will be instructed to carry out exercises with a first set of massaging elements and then carry out exercises with a second, different set of massaging elements. In this manner, the set of massaging element is changeable during the treatment, rather than being fixed.

Use of colored massaging elements is particularly important because it provides a way for the patient, particularly a child, to receive reinforcement in the therapy. For example, if the therapist instructs the patient to remove a blue massaging element from the container, the patient receives immediate visual feedback on identifying a blue massaging element, even before removing the blue massaging element from the container.

The large number of stimulating factors (color, size, protrusions) associated with the apparatus described with reference to FIGS. 1 and 7 is particularly helpful in carrying out exercises with a child with delayed neuropsychic development. Such a child can use the apparatus to carry out an exercise involving searching for massaging elements of the same size, color and weight, and the child can also arrange the massaging elements in a pattern.

The compression spring 8 helps heighten the effectiveness of the point massage because the resilience of the spring 8 provides a more even distribution of force on the biologically active points on the uneven surface of the palm. Also, the elasticity of the massaging element due to the compression spring reduces the likelihood that the hard material of the massaging element will cause injury to a child's skin. The complex structure of the hand allows different parts of the skin on the palm to move differentially when the massaging element is manipulated in the hand, e.g. by squeezing or rolling. The elasticity of the massaging element and the fact that the two hemispheres are connected together in a manner that allows relative rotation of the hemispheres allows relative movement of the hemispheres and reduces the possibility of discomfort or injury due to such differential movement.

Referring to FIGS. 9 and 10, it is desirable that the locations of the massaging protrusions on a spherical massaging element should be selected by a procedure that involves first inscribing a sphere with a polyhedron composed of regular polygons, such as hexagons and pentagons as shown in FIGS. 9 and 10, and then selecting as the locations of the massaging protrusions the vertices of the polygons and the points on the surface of the sphere that are radially outward of the centers of the polygons. By use of this procedure, it is ensured that the protrusion at the center of a polygon is equidistant from the protrusions at the vertices of the polygon.

Desirably, the container 1 has a narrow mouth so that a child who has one of the massaging elements grasped in his hand cannot withdraw his hand from the container until he has released the massaging element. Liquid may be placed in the container with the massaging elements for hydrotherapy or balneological therapy. It may be desirable to provide the container with a threaded lid or cover for sealing the container. In the event that the mouth of the container is wider, the patient may be able to insert both hands in the container for simultaneous exercise of the fingers of both hands, which may be advantageous for some treatments.

It will be appreciated that the invention is not restricted to the particular embodiment that has been described, and that variations may be made therein without departing from the scope of the invention as defined in the appended claims and equivalents thereof. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated.

1. A therapy apparatus comprising:
a container having an interior volume and having an opening providing access to said interior volume, and
a plurality of massaging elements freely located in the interior volume of the container, wherein each massaging element has a generally spherical exterior and has a plurality of protrusions projecting from said generally spherical exterior, whereby a patient who inserts his hand into the container through the opening and moves his fingers among the plurality of massaging elements is stimulated by massaging elements contacting his fingers both at the front and at the back of the hand.

2. An apparatus according to claim 1, wherein the massaging elements are of multiple colors.

3. An apparatus according to claim 1, wherein each massaging protrusion projecting from the generally spherical exterior of a massaging element is substantially equal to the distance from at least three other protrusions.

4. An apparatus according to claim 1, wherein the opening of the container is of smaller cross-sectional area than said interior volume.

5. An apparatus according to claim 1, wherein at least one of the massaging elements is hollow and contains an active element.

6. An apparatus according to claim 5, wherein the active element is a magnet element, a heat-emitting element, a sound-emitting element, or an aroma-emitting element.

7. An apparatus according to claim 1, wherein said plurality of massaging elements comprises multiple sets of massaging elements and each set of massaging elements comprises multiple massaging elements ranging in diameter from about 23-27 mm to about 35-40 mm.

8. An apparatus according to claim 1, wherein said plurality of massaging elements comprises multiple sets of massaging elements and each set of massaging elements differs from the other sets of massaging elements with respect to color.

9. An apparatus according to claim 8, wherein each of the massaging elements is hollow and contains an active element.

10. An apparatus according to claim 9, wherein each active element is a magnet element, a heat-emitting element, a heat-absorbing element, a sound-emitting element, or an aroma-emitting element and each set of massaging elements differs from the other sets of massaging elements with respect to the nature of the active element, whereby color of a massaging element is associated with the nature of the active element.

11. An apparatus according to claim 1, wherein the number of massaging elements is such relative to said interior volume of the container that there are at least two layers of massaging elements in the container.

12. An apparatus according to claim 1, wherein the massaging elements are all of the same size.

13. An apparatus according to claim 1, wherein the massaging elements are all of different respective sizes.

14. A method of administering therapy comprising:
providing a container having an interior volume and having an opening providing access to said interior volume, there being a plurality of massaging elements freely located in the interior volume of the container, wherein each massaging element has a generally spherical exterior and has a plurality of protrusions projecting from said generally spherical exterior, and
instructing a patient to insert his hand into the container through the opening and move his fingers among the plurality of massaging elements, whereby the patient's fingers are stimulated by massaging elements contacting the fingers both at the front and at the back of the hand.

15. A method according to claim 14, comprising diagnosing a condition of a first patient and associating a first set of massaging elements with the diagnosis, diagnosing a condition of a second patient and associating a second set of massaging elements, different from the first set, with the diagnosis of the second patient, placing the first set of massaging elements in the container, instructing the first patient to insert his hand into the container and move his fingers among the first set of massaging elements, removing the first set of massaging elements from the container, placing the second set of massaging elements in the container, and instructing the second patient to insert his hand into the container and move his fingers among the second set of massaging elements.

16. A method according to claim 14, comprising diagnosing a condition of a patient and associating at least first and second sets of massaging elements with the diagnosis, placing the first set of massaging elements in the container, instructing the patient to insert his hand into the container and force his fingers among the first set of massaging elements, removing the first set of massaging elements from the container, placing the second set of massaging elements in the container, and instructing the patient to insert his hand into the container and force his fingers among the second set of massaging elements.

17. A method according to claim 16, wherein the first set of massaging elements are the same as each other with respect to at least one of color and size, the second set of massaging elements are the same as each other with respect to at least one of color and size, and the first and second sets of massaging elements differ from each other with respect to at least one of color and size.

18. A method according to claim 16, wherein each massaging element contains an active element and the first and second sets of massaging elements differ from each other with respect to at least one of size, color and a characteristic of the active element.

19. A method according to claim 14, comprising placing liquid in the container with the massaging elements.

20. A massaging element having a generally spherical exterior and a plurality of substantially conical protrusions projecting from said generally spherical exterior, wherein the locations of the protrusions are selected by a method that comprises inscribing a spherical surface with a polyhedron composed of a plurality of regular polygons each having a center and multiple vertices, each vertex being common to exactly three polygons, and mapping the centers and the vertices of the polygons from the polyhedron onto the generally spherical exterior of the massaging element.

21. A massaging element according to claim 20, wherein the massaging element is hollow and contains an active element.

22. A massaging element according to claim 21, wherein the active element is a magnetic element.

23. A massaging element according to claim 21, wherein the active element is a heat-emitting element, a heat-absorbing element, a sound-emitting element, or an aroma-emitting element.

24. A massaging element according to claim 20, wherein the massaging protrusions are substantially conical.

25. A massaging element according to claim 20, wherein the massaging element is composed of two hemispheres provided with mating hollow cylindrical fastening elements each having interengaging latching members to prevent separation of the hollow hemispheres.

26. A massaging element according to claim 20, wherein the massaging element is composed of two hemispheres provided with mating fastening elements that allow relative rotation of the two hemispheres.

27. A massaging element according to claim 20, wherein the massaging element is composed of two hemispheres provided with mating fastening elements that allow limited relative linear movement of the hemispheres, and the massaging element further comprises a resilient member accommodated in the interior of the massaging element for urging the hemispheres apart.

28. A massaging element according to claim 27, wherein the resilient member is a compression spring.

29. A massaging element according to claim 20, wherein the massaging element comprises an electrifying material.
